(19) United States
(12) Patent Application Publication
(10) Pub. No.: US 2006/0237049 A1
(43) Pub. Date: Oct. 26, 2006

(54) Primary filter cleaning system for a dishwasher

(75) Inventors: David Clinton Weaver, Greenwood, MS (US); Jerry Wayne Ferguson, Greenwood, MS (US); John Frederick Morrison, Greenwood, MS (US); John Patrick Picardat, Greenwood, MS (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Viking Range Corporation

(21) Appl. No.: 11/113,569

(22) Filed: Apr. 25, 2005

(51) Int. Cl. B08B 7/04; B08B 3/04; B08B 3/00; B08B 3/12; B08B 9/20

(52) U.S. Cl. 134/56 D; 134/58 D; 134/25.2; 134/18; 134/10; 134/104.2; 134/184

(57) ABSTRACT

A dishwasher incorporates a primary filter cleaning system for removing food debris from circulated wash water. The dishwasher having a sump formed in the bottom and a wash pump having an inlet in communication with the sump. A collection chamber is formed through the bottom of the sump and a filter is situated over the top of the sump. The filter has an opening for depositing debris in the collection chamber. A stationary manifold is situated about the upper periphery of the sump and is aligned with the discharge of the pump. The manifold has multiple spaced spray nozzles, with each of the nozzles being aligned for spray contact with the filter. When water is pumped from the sump to the manifold, the water is sprayed across the filter to remove any food debris on the filter. The debris is then swept into the collection chamber.

### FIELD OF THE INVENTION

The present invention relates generally to a dishwasher, and, more particularly, to a dishwasher that incorporates a filter cleaning system for a primary wash water filter.

### BACKGROUND OF THE INVENTION

Conventional dishwashers utilize a drain and refill system that fills a dishwasher tub with fresh water at the beginning of the wash cycle to mix with and remove food soil from dishes. The cycle begins by drawing water through a pump that is controlled by a motor and that forces water onto dishes in the dishwasher through one or more spray arms. However, the fresh water soon becomes soil-laden as the food soils are removed from the dishes. The dishwashing cycle continues with the soil-laden water being drawn back into the pump through the pump inlet and sprayed back over the dishes. The dishwasher cycle then drains the soil-laden water from the dishwasher tub and repeats the cycle by refilling the tub with fresh water. This drain and refill sequence typically is based on a timed cycle with the draining occurring at a preset point in the overall wash cycle. This sequence repeats until the “dilution ratio” of fresh water to soil-laden water becomes high enough for the dishes to be considered relatively clean. However, the relative cleanliness of the dishes is based largely on the number of times the dishwasher drains the soil-laden water and refills the tub with fresh water. This cycling approach, however, has several drawbacks, including expending a great amount of water, energy, and time to remove the food soil from the surfaces of the dishes, and requiring a high-flow pressure wash system. Further, dishwashers that incorporate this cycling approach are relatively loud during drain and fill operations.

Prior dishwashers have attempted to solve some of these recycling problems to reach a high “dilution ratio” in a quieter, more consumer-friendly machine by including a filtration system. These filtration systems have helped to clean the dishes more effectively than non-filtered systems, using a minimal amount of water, and becoming vital components to help improve wash performance.

Typically, conventional dishwashers are equipped with one of two types of known filtration systems. The first and most desirable type of filtration system passes one hundred percent of the recirculated wash water through a “primary” filter. Where the primary dishwasher pump operates at a relatively high flow rate, however, keeping the filter clean and unblocked becomes increasingly difficult, especially when large amounts of food debris are suspended in the wash water.

The second type of filtration system utilizes partial flow filters in which only a portion of the water being pumped by the wash pump is filtered. This second type of filtration system is somewhat inefficient and ineffective since a portion of the suspended debris is re-pumped through the spray arms of the dishwasher and back onto the dishes, without first being filtered. Further, the pumping action of the wash pump essentially liquefies some of the food soils before the water is sprayed back onto the dishes. Although not as efficient as a full flow filtration system, if the primary filter becomes clogged, the pump and spray arms will continue to operate since some portion of the flow continues to feed the wash pump.

The efficiency and reliability of a dishwasher filtration system is ensured only if the primary filters can be kept clean. Current systems for cleaning primary filters utilize spray jets on the underside of the lower spray arm to spray across the surface of the filter. Unfortunately, there are several problems with the current cleaning systems. One such problem is that the cleaning jets, or nozzles, in each of these systems operate only when the lower spray arm and associated spray arm support are in operation; thus, if the lower spray arm becomes blocked for any reason, cleaning of the primary filter is halted. Another problem is that manufacturing tolerances in the construction of current dishwasher designs make it difficult to precisely aim the spray jets, which can result in only marginal effectiveness of the spray jets.

What is needed is a primary filter cleaning system that precisely and effectively sweeps away food soils from the filter media, yet operates independently of the moving spray arms of the dishwater.

These and other aspects of the present invention will become apparent to those skilled in the art after a reading of the following description of the preferred embodiment, when considered with the drawings.

### SUMMARY OF THE INVENTION

The present system solves the drawbacks of prior dishwashers by providing a dishwasher that incorporates a primary filter cleaning system for removing food debris from recirculated wash water in a dishwasher having a full flow primary filtration system. As is conventional, the dishwasher includes a cabinet with opposed side walls, a rear wall, a pivotal front door, a top wall, and a bottom. A sump is formed in the bottom, and a wash pump having a pump inlet is in fluid communication with the sump.

A collection chamber is formed through the bottom of the sump and extends upwardly from the sump as a tubular projection, or standpipe, having an open top. A primary filter is disposed over the open top of the sump and has an unfiltered opening formed therethrough that corresponds in shape and approximate size with the open top of the collection chamber.

The present filter cleaning system incorporates a stationary manifold that is positioned about the upper periphery of the sump and that is in fluid communication with the pump. The generally circular manifold has multiple spaced-apart spray nozzles, with each of the nozzles aligned for spray contact with the filter. As described in detail below, the collection chamber is located off-center of the sump center, and hence, off-center of the bottom of the dishwasher. Each of the spray nozzles is directed inwardly toward the collection chamber to direct food debris toward the collection chamber. When water is pumped under pressure from the sump to the manifold, the nozzles spray the water across the filter to remove any food debris on the filter and to sweep the debris into the collection chamber. In one embodiment, the filter is sloped downwardly from the upper periphery of the sump to the open top of the collection chamber so that the debris is more easily moved into the collection chamber.

As is conventional in dishwashers, a lower spray arm and an upper spray arm are provided and are also in fluid communication with the pump. However, the present invention further comprises a multi-position flow control valve downstream of the pump discharge. The multi-position flow control valve is selectively positionable to direct wash water flow from the sump to one or more of the stationary manifold, the lower spray arm, and/or the upper spray arm. When the primary filter is heavily laden with debris, the multi-position flow control valve is selectively positionable to direct all wash water flow from the sump to the stationary manifold. The pump motor controller logic provides one way to selectively direct the wash water flow. An electronic controller monitors load on the motor. The load on the motor is affected by the torque on the pump and varies as a function of the amount of food debris on the primary filter. When the torque on the motor reaches a preselected value, the electronic motor controller transmits a signal to the multi-position valve to direct some or all of the wash water flow to the stationary manifold. When the need for this directed flow is reduced or eliminated, flow is again reestablished to the upper and/or lower spray arms.

A second aspect of the present invention is directed to a method of operating a dishwasher to clean debris from a primary wash water filter. Broadly, the method comprises pumping filtered water through a wash water pump, and selectively directing the filtered water to either a stationary manifold, a lower spray arm, an upper spray arm, or a combination thereof.

These and other aspects of the present invention will become apparent to those skilled in the art after a reading of the following description of the preferred embodiments when considered in conjunction with the drawings. It should be understood that both the foregoing general description and the following detailed description are exemplary and explanatory only and are not restrictive of the invention as claimed.

### BRIEF DESCRIPTION OF THE DRAWINGS

FIG. 1 is a front perspective view of the present dishwasher.

FIG. 2 is a schematic view of the dishwasher of FIG. 1, illustrating the primary filter cleaning system.

FIG. 3 is a top schematic view of the primary filter cleaning system manifold.

FIG. 4 is a schematic view of the dishwasher illustrating filtered water flow through the primary filter cleaning system.

FIG. 5 is a top schematic view of the primary filter cleaning system manifold, illustrating flow through the manifold spray nozzles.

FIG. 6 is a side view of a multi-positional valve.

FIG. 7 is a top cutaway view of the valve of FIG. 6.

### DETAILED DESCRIPTION OF THE PREFERRED EMBODIMENTS

Certain exemplary embodiments of the present invention are described below and illustrated in the attached Figs. The embodiments described are only for purposes of illustrating the present invention and should not be interpreted as limiting the scope of the invention, which, of course, is limited only by the claims below. Other embodiments of the invention, and certain modifications and improvements of the described embodiments, will occur to those skilled in the art, and all such alternate embodiments, modifications and improvements are within the scope of the present invention.

The present invention is directed to a dishwasher that addresses the problems in the prior art by incorporating a novel dishwasher that incorporates a primary filter cleaning system for removing food debris from the primary wash water filter of the dishwasher.

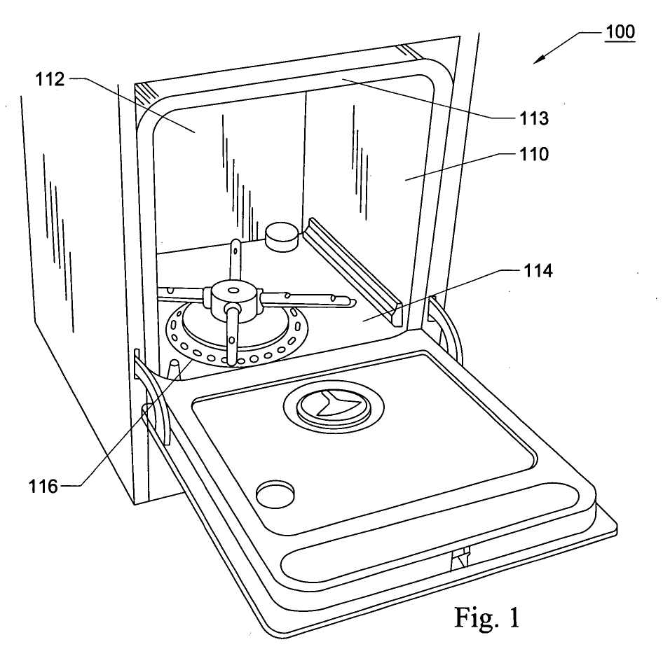

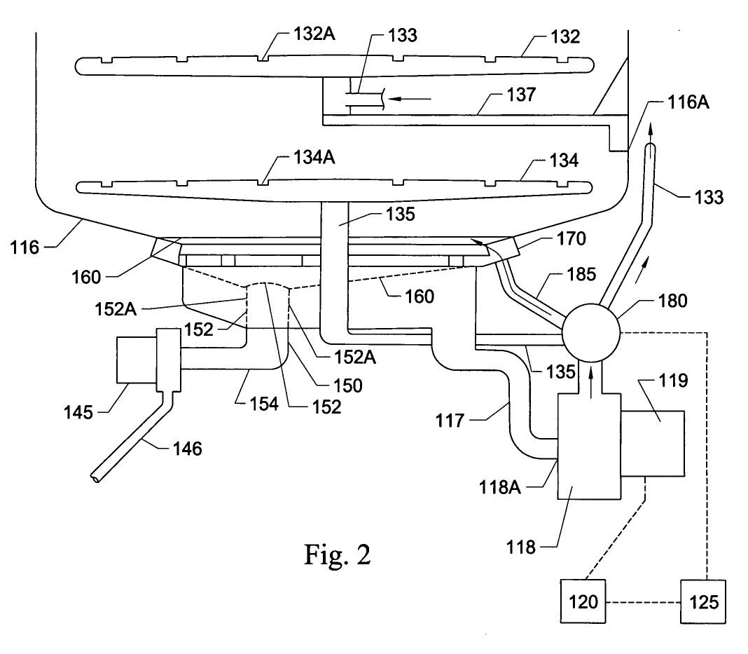

Referring to the Figs. in general, and FIGS. 1 and 2 in particular, a dishwasher 100 is shown. The dishwasher 100 includes opposed side walls 110, a rear wall 112, a top wall 113, and a bottom 114. A sump 116 is formed in the bottom 114, or tub, of the dishwasher 100. A wash pump 118 is situated level with, or below, the sump 116 and includes a wash water inlet 118a in fluid communication with the lower portion of the sump 116 through a suction line 117. The wash pump motor 119 is electrically connected to an electronic motor controller 120 that controls the wash cycle sequence during operation of the dishwasher 100. As shown in conventional dishwasher constructions, the pump 118 supplies filtered, recirculated wash water to an upper spray arm 132 and a lower spray arm 134, as will be described in greater detail below. The present dishwasher 100 further comprises a collection chamber 150 and a primary wash water filter 160 and cleaner 170.

The collection chamber 150 is formed through the bottom of the sump 116 and comprises a tube 152 that projects upwardly through the bottom of the sump 116. Because the support, or pedestal, for the lower spray arm typically extends upwardly from the geometric center of the bottom 114 of the dishwasher, the collection chamber 150 of the dishwasher described herein is located off-center of the dishwasher bottom 114 so that debris is more effectively swept into the collection chamber. This occurs because the rotating action of the lower spray arm tends to push water and debris away from the axis of the spray arm support. The upper spray arm 132 is supported from the sidewall of the dishwasher on a bracket 137. The lower portion 154 of the collection chamber provides a volume for receiving and temporarily holding solid debris apart from the recirculated wash water during the dishwashing cycle. At the end of the complete washing cycle, or pump out, an optional drain pump 145 pumps the solid debris and any residual water within the collection chamber 150 out through a connected drain hose 146. Optionally, the upper portion of the tube 152 of the collection chamber may further comprise one or more fine filter screens 152a that enable wash water that transports the debris into the collection chamber 150 to return by way of the fine screens 152a to the sump 116 for recirculation through the wash system.

The sump 116 of the embodiment shown in FIGS. 1 through 5 is generally circular; however, as will be appreciated, the shape and depth of the sump 116 are not limited thereto. Rather, the sump may have various shapes and depths so long as the sump accommodates and effectively collects the volume of water used in the washing cycle.

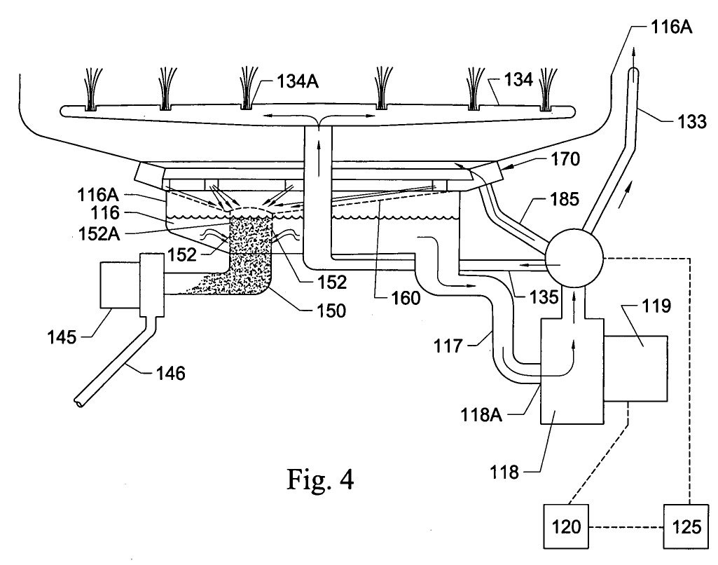

The primary wash water filter 160 comprises a mesh wire or plastic screen that is affixed over the open top of the sump 116. The primary filter 160 is positioned to filter out food debris that has been washed from the debris-laden dishes and that is larger than the individual openings in the primary filter 160. The smaller the openings in the filter, the larger the volume of debris that will be filtered from the dirty wash water, and vice versa. As best shown in FIGS. 2 and 4, the primary filter 160 generally slopes downwardly and inwardly from the upper periphery 116a of the sump 116 to the open top 152a of the collection chamber tube 152 so that debris may be more easily urged into the collection chamber 150.

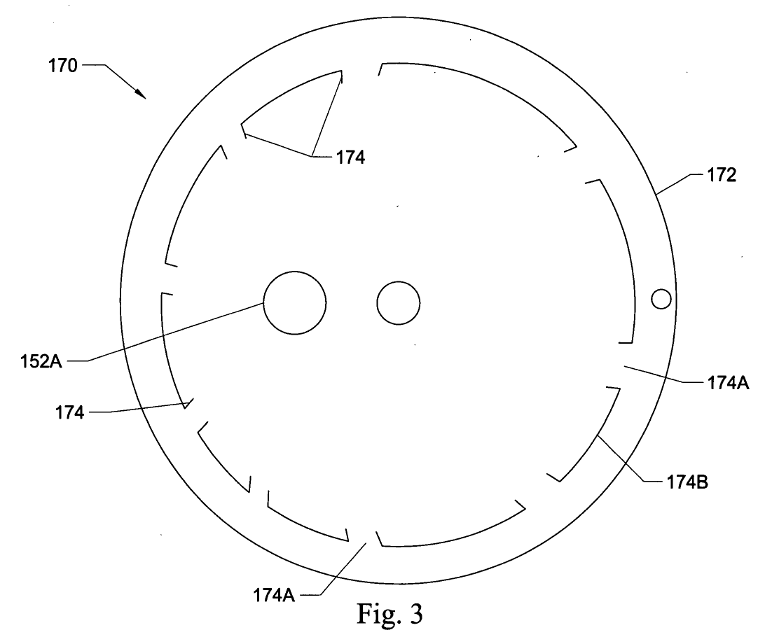

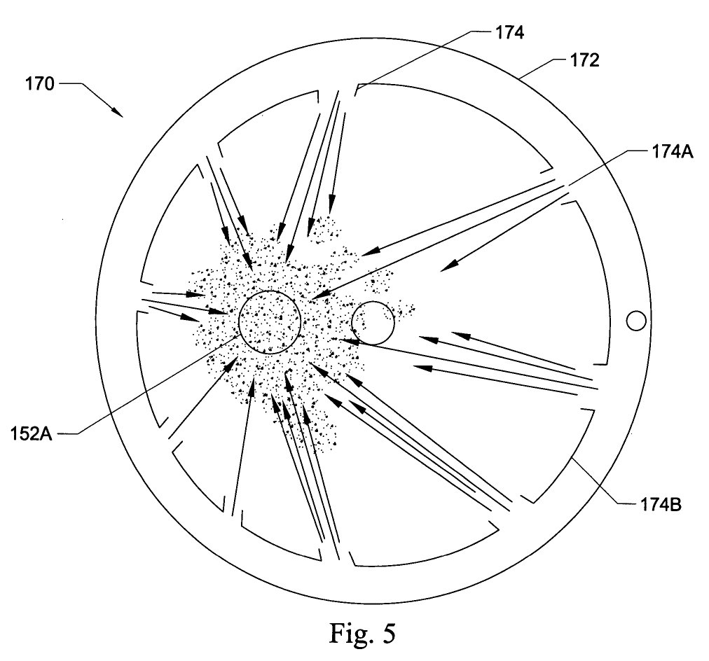

Unlike the constantly rotating cleaning jets currently formed in the underside of the lower spray arms 134 of conventional dishwashers, the present dishwasher 100 utilizes a fixed primary filter cleaner 170. Referring now to FIG. 3, in one embodiment, the primary filter cleaner 170 comprises a stationary manifold 172 that is situated around the upper periphery 116a of the sump 116, and is elevated slightly higher than the primary filter 160. As used herein, “manifold” generally refers to a pipe or chamber having multiple apertures for making connections. In the embodiment shown in FIGS. 3 and 5, the manifold 172 is a continuous circular ring, corresponding in approximate diameter to the upper periphery 116a of the sump 116, and having a generally round cross-section. A plurality of spaced nozzles 174 project inwardly from apertures 174a that are formed through the inner wall 174b of the manifold 172. It will be appreciated that the manifold 172 need only conform generally to the periphery 116a of the sump, and hence, the shape of the primary filter 160. Further, the manifold 172 is not limited to a round cross-section; rather, any cross-section that is suited for unobstructed fluid flow and distribution may be utilized.

Additionally, in view of the purpose and function of the filter cleaner 170, a manifold 172 is but one structure capable of providing jets of pressurized cleaning water to the primary filter. For example, a series of individual cleaning water supply lines, each terminating in a nozzle, could be employed, rather than a manifold. Similarly, when the primary filter is constructed as a manifold, it need not be continuous. For example, the manifold may be C- or U-shaped, etc.

Each of the nozzles 174 are specifically directed and aligned for spray contact across the surface of the primary filter 160; i.e., the spray is directed generally parallel to, but in contact with, the surface of the filter 160, such that a sweeping action is produced across the filter 160. As shown in FIG. 3, because the collection chamber 150 is off-center of the center of the sump 116, each nozzle 174 is angled inwardly at a slightly different angle so that each nozzle 174 directs a jet of cleaning water flow toward the open top 152a of the collection chamber 150. As long as the required volume and pressure of the cleaning wash flow is sufficient to sweep away the debris that has been trapped by the primary filter 160, no maximum or minimum number of required nozzles is required.

The pump 118 pumps the filtered wash water from the sump 116 and discharges all of the water through a discharge line 118a to a multi-position flow control valve 180. The multi-position flow control valve 180 is configured to be selectively positionable to direct flow to the stationary manifold 170, the lower spray arm 134, the upper spray arm 132, all three, or any combination of the three. The motor 119 that drives the pump 118 is connected to the electronic motor controller 120. The electronic motor controller 120 is, in turn, electrically connected to a dishwasher flow controller 125. The dishwasher controller 125 is electrically connected to the multi-position flow control valve 180 to control how and where the valve directs the filter wash water flow. Separate discharge lines direct flow to the selected mechanisms; i.e., line 185 directs flow from the valve 180 to the primary filter cleaner 170, line 133 directs flow from the valve 180 to the upper spray arm 132, and line 135 directs flow from the valve 180 to the lower spray arm 134.

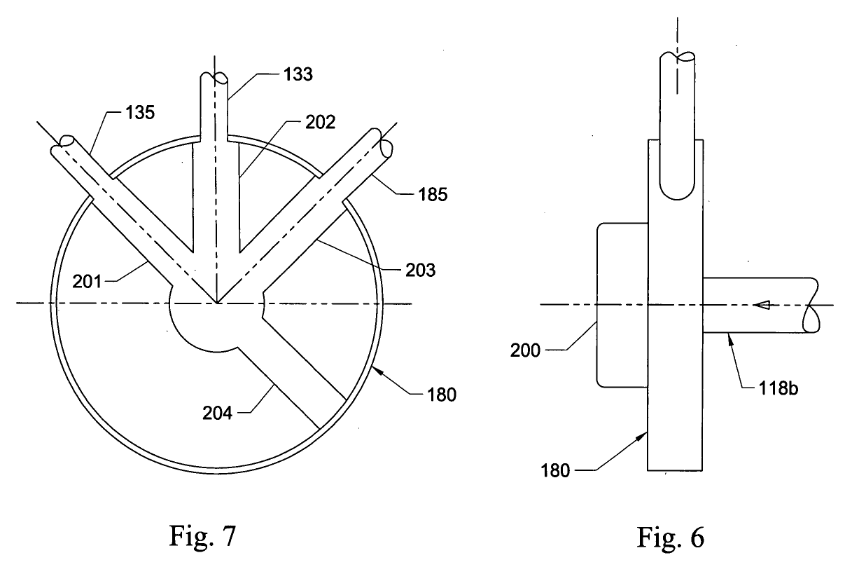

The side view of the multi-positional valve 180 shown in FIG. 6 illustrates that the valve 180 has a drive motor 200 that is controlled by the controller 125. The inlet to the multi-positional valve 180 is through the inlet line 118b from the pump 118. The valve 180 then has the three outlet lines 133, 135, and 185 as previously described. FIG. 7 is a cross sectional view of the valve 180 illustrating how the water flow may be directed to any one of the three outlet lines 133, 135, or 185 or any combination of these lines. The drive motor 200 can rotate through a central series of passageways 201, 202, 203, and 204. These passageways are connected to the inlet line 118b. As seen in FIG. 7, passageway 201 aligns with line 133, passageway 202 aligns with line 135, and passageway 203 aligns with line 185. In this configuration, water is supplied to all three outlet lines 133, 135, and 185. The line 204 is generally a shutoff switch and, in the configuration shown in FIG. 7, is shown as blocked against the wall of the valve 180. Passageways 201-204 can be rotated by the drive motor 200 to give a variety of flow combinations. For example, to supply water only to the lower spray arm 134 through the line 135, the passageway 204 is aligned with the line 133. If this rotation takes place, the passageways 201, 202, and 203 would be blocked against the wall of the valve 180 and could not supply any water. In order to only supply the upper spray arm 132 through its line 133, passages 201-204 are rotated again to align passage 204 with line 133. In this situation, liquid is supplied only through the line 133 because the passageways 201, 202, and 203 are blocked against the side of the valve 180. Finally, to supply only the filter cleaning conduit 185, passageways 201-204 would be rotated to bring passageway 201 into alignment with line 185. In this configuration, passageways 202, 203, and 204 would be blocked against the wall of the valve 180 and liquid would be supplied only through line 185. Thus, various combinations of flows are possible to supply water to either of, or all of, spray arms 134 and 132 and/or the filter cleaning conduit 185.

If desired, individual valves, all of which would be controlled by the system controller 125, can replace the multi-positional valve 180. However, a single multi-positional valve such as 180 is preferred to simplify operation and construction.

In operation, the wash pump 118 directs wash water flow to the upper and lower spray arms 132, 134 during the normal dishwashing cycle. The lower and upper spray arms each have spaced nozzles 132a, 134a that project upwardly for washing action on the dishes in the upper and lower dish racks (not shown), respectively, as the spray arms rotate about a central support 135. In many instances, the dishes will be heavily laden with food debris to be cleaned away. The washing action of the spray arms removes food debris from the dishes, with the soiled water and debris falling downwardly to the tub of the dishwasher. As the water passes through the primary filter 160 that covers the top of the sump 116, the primary filter 160 entraps larger particles of food debris. The filtered dishwater that is collected in the sump is then drawn back through the wash water pump 118 and the cycle is repeated until such time as a final rinsing step is completed with fresh water.

As the dishwashing cycle progresses, the primary filter 160 gradually becomes covered and blocked by the food debris being washed from the dishes. The amount of time for the filter 160 to become significantly blocked is dependent upon the amount of food debris on the dishes. If no remedial action is taken, the filter becomes more clogged and the water is unable to pass through the filter 160 into the sump 116, eventually starving the wash pump of water 118. As air is drawn into the pump, the pump loses prime (i.e., when prime on the pump is broken). Once prime is broken, pumping action is greatly reduced or stopped and all cleaning action through the spray arms 132, 134 is halted.

The system 170 of the present invention remedies this problem. As the filter 160 becomes clogged, less wash water passes through the primary filter, i.e., backing up into the tub, the torque on the pump abates. When the pump begins drawing air, the torque level diminishes significantly. The electronic controller 120 monitors the load on the motor 119 and transmits a signal to the dishwasher controller 125 that controls the multi-position valve 180. This signal is sent when the torque on the motor diminishes to a preselected value.

When the primary filter 160 is blocked significantly, as indicated by the control signal, the multi-position valve 180 stops directing flow to the spray arms 132, 134 and directs all flow to the stationary manifold 172. By stopping flow to the spray arms, only the cleaning jets 174 of the stationary manifold 172 are provided and require flow. Thus, the maximum amount of available water volume and pressure is delivered to the cleaning nozzles 174. As the primary filter 160 is cleared of debris, the dishwasher controller 125 can selectively restore flow to the spray arms 132, 134, ultimately stopping or reducing flow to the primary filter cleaner 170.

Another aspect of the present invention is directed to a method of operating a dishwasher to sweep debris from a primary wash water filter. The method comprises a step of pumping filtered water from the dishwasher sump to a stationary manifold that is affixed around the periphery of the sump, and hence around the primary filter. The manifold has a plurality of spaced nozzles extending inwardly therefrom and directed against the surface of the primary filter. The filtered water is then sprayed across the filter, sweeping debris from the primary filter and into a collection chamber.

Yet another aspect of the present invention is directed to a method of controlling the flow of circulated, filtered wash water in a dishwasher having a lower spray arm, an upper spray arm, and a stationary primary filter cleaner. Again, filtered water is pumped through the wash water pump. A flow control device then selectively directs the filtered water to the lower spray arm, upper spray arm, stationary filter cleaner, or any combination of the three. The flow control device comprises a multi-position flow control valve. During the normal washing cycle, all of the flow is directed to the upper and lower spray arms to accomplish the wash function. This is the flow scheme when the filter is not overloaded or blocked by debris. The electronic controller monitors the load on the pump, which provides an indication of the degree of clogging on the primary filter. When the torque on the motor reaches a preselected value, the electronic controller transmits a signal to the multi-position flow control valve to direct at least some of the wash water flow to the stationary primary filter cleaner. If the load/torque on the motor falls far enough, all of the flow is directed to the primary filter cleaner, wherein a higher flow rate, and thus a higher water pressure is delivered to the filter cleaner for sweeping the debris from the primary filter to the collection chamber.

While the invention has been disclosed in its preferred forms, it will be apparent to those skilled in the art that many modifications, additions, and deletions can be made therein without departing from the spirit and scope of the invention in its equivalents as set forth in the following claims.

We claim:

1. A dishwasher incorporating a primary filter cleaning system for removing food debris from recirculated water, the dishwasher comprising:
a dishwasher tub, a sump formed in a lower portion of the dishwasher tub, and a pump having a pump inlet in communication with the sump and a pump discharge, the sump having a bottom, an open top, and an upper periphery;
a collection chamber formed in the bottom of the sump;
a filter disposed over the open top of the sump and having an opening therein for communication with the collection chamber;
a stationary manifold about the upper periphery of the sump and in fluid communication with the pump, the manifold having a plurality of spaced spray nozzles, each of the nozzles aligned for spray contact with the filter; and
wherein when water is pumped from the sump to the manifold, the water is sprayed across the filter to remove any food debris thereon, with the debris proceeding into the collection chamber.

2. The dishwasher of claim 1, further including a drain pump in communication with the collection chamber for drainage of the food debris therefrom.

3. The dishwasher of claim 1, wherein each of the spray nozzles is directed inwardly toward the collection chamber to direct the food debris to the collection chamber.

4. The dishwasher of claim 1, wherein the filter slopes downwardly from the upper periphery of the sump to the collection chamber.

5. The dishwasher of claim 1, wherein the upper periphery of the sump is substantially round.

6. The dishwasher of claim 1, further including:
a lower spray arm in fluid communication with the pump; and
an upper spray arm in fluid communication with the pump.

7. The dishwasher of claim 6, further including:
a multi-position flow control valve downstream of the pump discharge; and
wherein the multi-position flow control valve is selectively positionable to simultaneously direct the water to at least one of the stationary manifold, the lower spray arm, and the upper spray arm.

8. The dishwasher of claim 7, wherein the multi-position flow control valve is selectively positionable to direct all the water to the stationary manifold.

9. The dishwasher of claim 7, further including:
a motor that controls the pump; and
an electronic controller that monitors load on the motor, wherein the food debris on the primary filter varies the load on the motor.

10. The dishwasher of claim 9, wherein when the load on the motor is set at a preselected value, the electronic controller transmits a signal to the multi-position valve to direct the water to the stationary manifold.

11. A method of operating a dishwasher to clean debris from a primary filter, the method comprising:
pumping filtered water to a stationary manifold situated about the filter and having a plurality of spaced nozzles aligned toward the filter; and
spraying the filtered water from the plurality of spaced nozzles across the filter to move the debris from the filter to a collection chamber.

12. A method of controlling the flow of circulated, filtered water in a dishwasher having at least one spray arm and a stationary manifold situated about the primary filter of the dishwater, comprising the steps of:
pumping filtered water through a pump;
selectively directing the filtered water to at least one of the stationary manifold or the at least one spray arm.

13. The method of claim 12, wherein the at least one spray arm comprises:
a lower spray arm; and
an upper spray arm.

14. The method of claim 13, wherein all of the filtered water is directed to the stationary manifold and at least one of the upper spray arm and the lower spray arm.

15. The method of claim 13, wherein all of the filtered water is directed to at least one of the upper spray arm or the lower spray arm.

16. The method of claim 12, wherein the filtered water is selectively directed by manipulating a multi-position flow control valve.

17. The method of claim 12, wherein all of the filtered water is directed to the stationary manifold, wherein a higher flow rate is obtained to sweep debris from the primary filter to the collection chamber.

18. The method of claim 12, further including:
controlling the pump with a motor; and
monitoring load on the motor with an electronic controller, wherein soil debris on the primary filter varies the load on the motor.

19. The dishwasher of claim 18 wherein the electronic controller transmits a signal to a multi-position valve to direct the water to the stationary manifold when the load on the motor reaches a preselected value.
